(19) United States
(12) Patent Application Publication
(10) Pub. No.: US 2004/0190541 A1
(43) Pub. Date: Sep. 30, 2004

(54) Determination of optimal switching points between the uplink and downlink

(75) Inventor: Guodong Zhang, Patchogue, NY (US)

Correspondence Address: VOLPE AND KOENIG, P.C., DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE

(21) Appl. No.: 10/808,875

(22) Filed: Mar. 25, 2004

Related U.S. Application Data
(60) Provisional application No. 60/457,941, filed on Mar. 26, 2003.

(51) Int. Cl. H04J 3/00

(52) U.S. Cl. 370/431; 370/458

(57) ABSTRACT

A wireless communication system has a variable number of time slots or frequencies allocated to support either uplink or downlink communications. Time slots or frequencies available for allocation to support either uplink or downlink communications are determined. Potential switching points between the available time slots or frequencies are determined. The switching points represent a change between time slots or frequencies used to support uplink and downlink communications. For each switching point, for each of uplink and downlink, a number of user that can be supported is determined by comparing a blocking probability of real time services with a required blocking probability of real time services and an average delay of non-real time services with a required average delay of non-real time services is compared. A minimum of the uplink and downlink users is selected that can be supported as the number of users that can be supported for that switching point. The switching point having a maximum number of users that can be supported is selected. The available uplink and downlink time slots or frequencies are allocated based on the selected switch point.

### CROSS REFERENCE TO RELATED APPLICATION

This application claims priority from U.S. Provisional Patent Application Serial No. 60/457,941, filed Mar. 26, 2003, which is incorporated by reference as if fully set forth herein.

### FIELD OF THE INVENTION

This invention relates generally to wireless communication systems, and more particularly, to determining uplink and downlink resource allocations.

### BACKGROUND

In many communication systems, uplink and downlink transmissions are separated, such as by frequency and/or time slots. One such system is the proposed wideband code division multiple access (WCDMA) frequency division duplex (FDD) mode, which separates the uplink and downlink by frequency. By contrast, the WCDMA time division duplex (TDD) mode separates the uplink and downlink by time slots, in response to uplink and downlink traffic demands.

For voice based communication systems, uplink and downlink demand is typically symmetrical, allowing for efficient symmetrical frequency allocations in FDD and time slot allocations in TDD type systems. Since more and more asymmetric wireless services are being utilized, such as Internet browsing, asymmetric allocations of frequencies/time slots are needed. To illustrate, in an FDD system, more downlink frequency bands may be needed than uplink or, in a TDD system, more downlink time slots may be needed than uplink. An incorrect allocation of these frequency bands/time slots leads to an under utilization of the radio resources.

Accordingly, it is desirable to have efficient approaches to allocating uplink and downlink resources.

### SUMMARY

A wireless communication system has a variable number of time slots or frequencies allocated to support either uplink or downlink communications. Time slots or frequencies available for allocation to support either uplink or downlink communications are determined. Potential switching points between the available time slots or frequencies are determined. The switching points represent a change between time slots or frequencies used to support uplink and downlink communications. For each switching point, for each of uplink and downlink, a number of user that can be supported is determined by comparing a blocking probability of real time services with a required blocking probability of real time services and an average delay of non-real time services with a required average delay of non-real time services is compared. A minimum of the uplink and downlink users is selected that can be supported as the number of users that can be supported for that switching point. The switching point having a maximum number of users that can be supported is selected. The available uplink and downlink time slots or frequencies are allocated based on the selected switch point.

### BRIEF DESCRIPTION OF THE DRAWING(S)

A more detailed understanding of the invention may be had from the following description of a preferred example, given by way of example and to be understood in conjunction with the accompanying drawing wherein:

FIG. 1 illustrates state transitions of two adjacent states for real time services.

FIG. 2 illustrates the state transition of two adjacent states for non-real time services.

FIG. 3 is a flow diagram of frequency band/time slot switch point determination.

FIGS. 4A and 4B are simplified diagrams of a wireless system using optimum switching points.

### DETAILED DESCRIPTION OF THE PREFERRED EMBODIMENTS

Although optimum switching point determination is described in conjunction with FDD and TDD wireless systems, such as W-CDMA FDD and TDD modes, time division synchronous CDMA (TD-SCDMA) and CDMA 2000, the embodiments are applicable to any communication system where the uplink and downlink are separated by variable resources. The following description is made in the context of a TDD system, although it can be applied to an FDD system by using frequency bands instead of time slots.

ATDD system supports both real-time and non-real-time services. If the number of wireless users, such as wireless transmit/receive units (WTRUs), in a cell is N_{subscriber} and M−1 types of real-time service (j=1, 2, M−1), e.g., voice, video, etc., exist, each user of a real-time service has a Poisson call arrival rate of λ_{subscriber}(j) for service type j. The total Poisson call arrival rate for service type j in the cell, denoted by λⱼ, is N_{subscriber}·λ_{subscriber} (j).

The service time of service type j (=1, 2, M−1) follows an exponential distribution with a mean of 1/μⱼ. One type of generic non-real-time service is denoted by service type M. Each user has a Poisson packet arrival rate of λ_{subscriber}(M) for the non-real-time service. The total Poisson packet arrival rate in the cell, denoted by λ_{M}, equals N_{subscriber}·λ_{subscriber}(M). The service time of the non-real-time packet follows an exponential distribution with a mean of 1/μ_{M}. The data rate of a service type j (j=1, 2, M) is Rⱼ, and the required energy per bit to noise ratio is (E_{b}/N₀)ⱼ. The requirement for the blocking probability of real-time service type j (j=1, 2, . . . , M−1) is assumed to be P_{B}_{_{—}}_{^{req}} (j), and the requirement for the average delay of non-real-time service is D_{req}.

Real-time calls are either admitted or blocked, while non-real-time packets can be buffered until resources are available. Therefore, real-time services have preemptive priority over the non-real-time service. For simplicity, the following assumes no priority exists between real-time services.

The load of an uplink time slot in TDD system is denoted by:

$${Load}_{UL\_Slot} = ( {β}_{UL} + {η}_{UL} ) \cdot {\sum }_{i = 1}^{N} \frac{1}{1 + \frac{W / S}{{( {E}_{b} / {N}_{0} )}_{i} \cdot {R}_{i}}} \qquad Equation ( 1 )$$

β_{UL} is the multi-user detection (MUD) residual factor in the uplink, which is the fraction of intracell interference that cannot be cancelled by the MUD. η_{UL} is the average inter-to-intracell interference ratio in the uplink, and W/S is the equivalent chip rate of one time slot in a TDD system. When Load_{UL}_{_{—}}_{^{Slot}} approaches 1, the uplink capacity reaches its maximum, pole capacity, where the uplink interference goes to infinity.

Suppose that there are S_{UL} time slots in the uplink. ψⱼ denotes

$$( {β}_{UL} + {η}_{UL} ) \cdot \frac{1}{1 + \frac{W / S}{{( {E}_{b} / {N}_{0} )}_{j} {R}_{j}}}$$

for service type j. If there is a total of Nⱼ users of service type j in the uplink, the total load of all uplink time slots can be expressed as:

$${Load}_{UL} = {\sum }_{j = 1}^{M} {ψ}_{j} \cdot {N}_{j} \qquad Equation ( 2 )$$

Since the load of each uplink time slot has to be less than 1, the total load of S_{UL} time slots is less than S_{UL}.

The load of a downlink time slot in TDD system is expressed as:

$${Load}_{DL\_Slot} = ( {β}_{DL} + {η}_{DL} ) \cdot {\sum }_{i = 1}^{N} \frac{{( {E}_{b} / {N}_{0} )}_{i} \cdot {R}_{i}}{W / S} \qquad Equation ( 3 )$$

β_{DL} is the MUD residual factor in the downlink, and η_{DL} is the average inter-to-intracell interference ratio in the downlink. When Load_{DL}_{_{—}}_{^{Slot}} approaches 1, the downlink capacity reaches its maximum, pole capacity, where the base station (BS) transmit power goes to infinity. Suppose that there are S_{DL} time slots in the downlink. ψⱼ denotes

$$( {β}_{DL} + {η}_{DL} ) \cdot \frac{{( {E}_{b} / {N}_{0} )}_{j} \cdot {R}_{j}}{W / S}$$

for service type j. If there are a total of Nⱼ users of service type j in the downlink, the total load of all downlink time slots can be expressed as denoted in Equation (4) as:

$${Load}_{DL} = {\sum }_{j = 1}^{M} {ψ}_{j} \cdot {N}_{j} \qquad Equation ( 4 )$$

Since the load of each downlink time slot is less than 1, the total load of S_{DL} time slots is less than S_{DL}.

In TDD systems, linearity between pole capacities of different servers may not exist as shown in equations (1) and (3). As a result, it cannot be modeled as a system that has a certain number of servers and wherein each user requests a certain number of servers.

The real-time services have preemptive priority over the non-real-time service. Therefore, the non-real-time services have no influence on the performance of real-time services. A multiple-class Markov chain is used to model the behavior of real-time services (j=1, 2, . . . , M−1) in the system. For TDD systems, the load in the direction of interest (uplink or downlink) cannot exceed a certain maximum allowed value, denoted by Loadₘₐₓ. (X₁, . . . ,X_{M-1}) denotes the state where there are Xᵢ calls of service type i in the system, and P(X₁, . . . X_{M-1}) denotes the corresponding state probability. The allowed state for this system is denoted by Ω_{RT}, and is defined as:

$${Ω}_{RT} = \{ ( {X}_{1} , … , {X}_{M - 1} ) \vert {\sum }_{j = 1}^{M - 1} {ψ}_{j} \cdot {X}_{j} \leq {Load}_{max} \} \qquad Equation ( 5 )$$

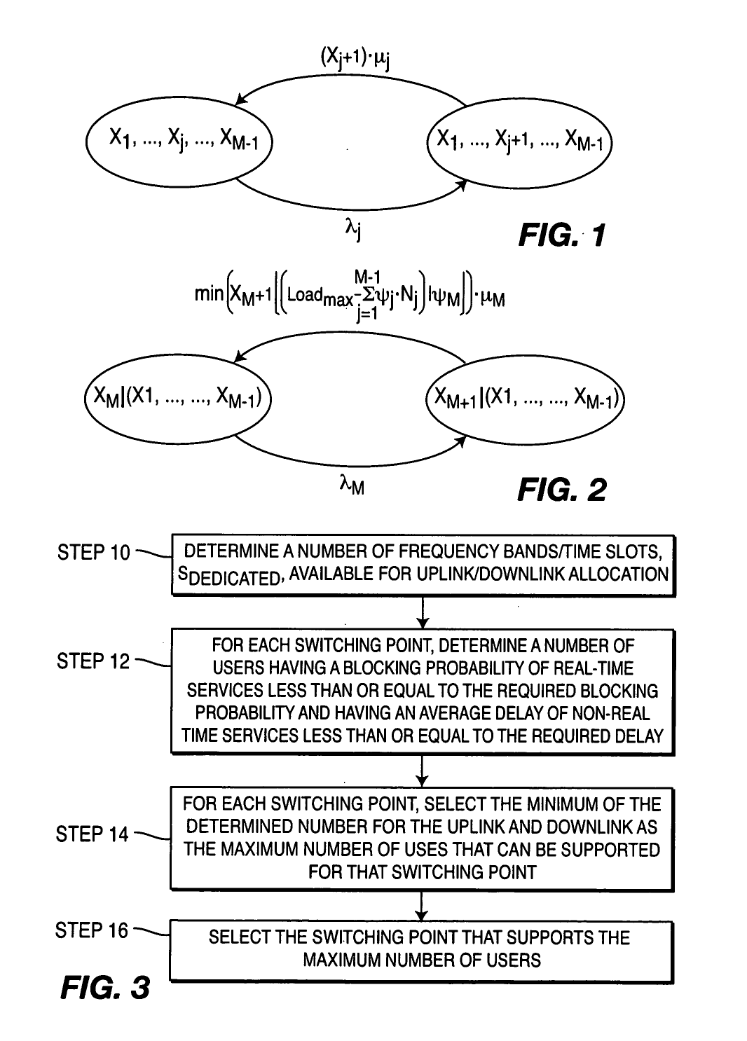

FIG. 1 shows the state transitions of two adjacent states. The flow balance equation is denoted as Equation (6) and, equivalently, by Equation (7):

λⱼ·P(X₁, . . . , X_{M-1})=(Xⱼ+1)·μⱼ·P(X₁, . . . , Xⱼ+1, . . . , X_{M-1}) Equation (6)

$$P ( {X}_{1} , … , {X}_{j} + 1 , … , {X}_{M - 1} ) = \frac{{λ}_{j}}{{μ}_{j}} \cdot \frac{1}{{X}_{j} + 1} \cdot P ( {X}_{1} , … , {X}_{j} , … , {X}_{M - 1} ) \qquad Equation ( 7 )$$

Using Equation (6) and Equation (7), Equation (8) and Equation (9) result:

$$\begin{matrix}P ( {X}_{1} , … , {X}_{M - 1} ) = ( {\prod }_{j = 1}^{M - 1} {( \frac{{λ}_{j}}{{μ}_{j}} )}^{{X}_{j}} \cdot \frac{1}{{X}_{j} !} ) \cdot P ( 0 , … , 0 ) & Equation ( 8 ) \\ and {\sum }_{( {X}_{1} , … , {X}_{M - 1} ) ∈ {Ω}_{RT}} P ( {X}_{1} , … , {X}_{M - 1} ) = 1 & Equation ( 9 )\end{matrix}$$

The state probability P(X₁, . . . ,X_{M-1}) is solved per:

$$P ( {X}_{1} , … , {X}_{M - 1} ) = \frac{( {\prod }_{j = 1}^{M - 1} {( \frac{{λ}_{j}}{{μ}_{j}} )}^{{X}_{j}} \cdot \frac{1}{{X}_{j} !} )}{{\sum }_{( {X}_{1} , … , {X}_{M - 1} ) ∈ {Ω}_{RT}} ( {\prod }_{j = 1}^{M - 1} {( \frac{{λ}_{j}}{{μ}_{j}} )}^{{X}_{j}} \cdot \frac{1}{{X}_{j} !} )} \qquad Equation ( 10 )$$

The behavior of non-real-time services depends on how many real-time calls are being served in the system. Markov modulated Poisson process (MMPP) is used to model the behavior of non-real-time service in the system. (X_{M}|X₁, . . . , X_{M-1}) denotes the state when there are X_{M} non-real-time packets in the system given that there are Xᵢ real-time calls of service type i in the system, and P(X_{M}|X₁, . . . , X_{M-1}) denotes the corresponding state probability. Since queuing is allowed for non-real-time services when all servers are busy, the allowed states for this system, Ω_{NRT}, becomes ∞. Non-real-time packets can only utilize the resources that are not used by real-time calls. The number of non-real-time packets that can be served when there are Xᵢ real-time calls of service type i in the system is given by

$$⌊ ( {Load}_{max} - {\sum }_{j = 1}^{M - 1} {ψ}_{j} \cdot {X}_{j} ) / {ψ}_{M} ⌋ ,$$

where [x] is the largest integer that does not exceed x. With only X_{M} packets in the system, the actual throughput of non-real-time service (number of packets being served) is denoted by T(X_{M}|X₁, X₂, . . . , X_{M-1}) as:

$$T ( {X}_{M} \vert {X}_{1} , … , {X}_{M - 1} ) = min ( {X}_{M} , ⌊ ( {Load}_{max} - {\sum }_{j = 1}^{M - 1} {ψ}_{j} \cdot {X}_{j} ) / {ψ}_{M} ⌋ ) \qquad Equation ( 11 )$$

The state transitions of two adjacent states are shown in FIG. 2. The flow balance equation is denoted as:

λ_{M}·P(X₁, . . . , X_{M-1})=T(X_{M}+1|X₁, . . . , X_{M-1})·μ_{M}·P(X_{M}+1|X₁, . . . , X_{M-1}) Equation (12)

Using Equation (12), Equation (13) and Equation (14) result:

$$\begin{matrix}P ( {X}_{M} \vert {X}_{1} , … , {X}_{M - 1} ) = {\prod }_{i = 1}^{{X}_{M}} ( \frac{{λ}_{M}}{{μ}_{M}} \cdot \frac{1}{T ( i \vert {X}_{1} , … , {X}_{M - 1} )} ) \cdot P ( 0 \vert {X}_{1} , … , {X}_{M - 1} ) \\ and \\ & Equation ( 13 ) \\ {\sum }_{{X}_{M} ∈ {Ω}_{NET}} P ( {X}_{M} \vert {X}_{1} , … , {X}_{M - 1} ) = 1 & Equation ( 14 )\end{matrix}$$

P(X_{M}|X₁, . . . , X_{M-1}) is solved per:

$$P ( {X}_{M} \vert {X}_{1} , … , {X}_{M - 1} ) = \frac{{\prod }_{i = 1}^{{X}_{M}} ( \frac{{λ}_{M}}{{μ}_{M}} \cdot \frac{1}{T ( i \vert {X}_{1} , … , {X}_{M - 1} )} )}{{\sum }_{{X}_{M} ∈ {Ω}_{NRT}} {\prod }_{i = 1}^{{X}_{M}} ( \frac{{λ}_{M}}{{μ}_{M}} \cdot \frac{1}{T ( i \vert {X}_{1} , … , {X}_{M - 1} )} )} \qquad Equation ( 15 )$$

Since real-time services have preemptive priority over the non-real-time service, non-real-time service has no influence on the performance of real-time services. A service type i real-time new call will be blocked when the current load generated by real-time services plus the load of the new call exceeds the maximum allowed load.

Bᵢ denotes the subset of states in which service type i new call will be blocked and is per:

$${B}_{i} = \{ ( {X}_{1} , {X}_{2} , … , {X}_{M - 1} ) \vert {Load}_{max} - {ψ}_{i} < {\sum }_{j = 1}^{M - 1} {ψ}_{i} \cdot {X}_{j} \leq {Load}_{max} \} \qquad Equation ( 16 )$$

The blocking probability for service type i is given by the sum of state probabilities of those states that meet the blocking criteria.

$${P}_{blocking} ( i ) = {\sum }_{( {X}_{1} , … , {X}_{M - 1} ) ∈ {B}_{i}} P ( {X}_{1} , … , {X}_{M - 1} ) \qquad Equation ( 17 )$$

The average number of non-real-time packets in the system, including packets waiting in the queue and packets being served, is denoted by \overline{L} as follows:

$$\overline{L} = {\sum }_{( {X}_{1} , … , {X}_{M - 1} ) ∈ {Ω}_{RT}} ( {\sum }_{{X}_{M} ∈ {Ω}_{NRT}} {X}_{M} \cdot P ( {X}_{M} \vert {X}_{1} , … , {X}_{M - 1} ) ) \cdot P ( {X}_{1} , … , {X}_{M - 1} ) \qquad Equation ( 18 )$$

The average throughput of non-real-time packets, Xᵢ real-time calls of service type i in the system, is denoted by \overline{T}_{|(X}_{₁}_{^{, . . . , X}}_{_{M-1}}_{⁾} as follows:

$${\overline{T}}_{\vert ( {X}_{1} , … , {X}_{M - 1} )} = {\sum }_{{X}_{M} ∈ {Ω}_{NRT}} T ( {X}_{M} \vert {X}_{1} , … , {X}_{M - 1} ) \cdot P ( {X}_{M} \vert {X}_{1} , … , {X}_{M - 1} ) \qquad Equation ( 19 )$$

The average throughput of non-real-time packets, denoted by \overline{T} is per:

$$\overline{T} = {\sum }_{( {X}_{1} , … , {X}_{M - 1} ) ∈ {Ω}_{RT}} {\overline{T}}_{\vert ( {X}_{1} , … , {X}_{M - 1} )} \cdot P ( {X}_{1} , … , {X}_{M - 1} ) \qquad Equation ( 20 )$$

The average delay of non-real-time service is denoted by \overline{D} as:

$$\overline{D} = \frac{\overline{L}}{\overline{T}} \cdot \frac{1}{{μ}_{M}} \qquad Equation ( 21 )$$

For S_{dedicated} time slots used for dedicated physical channels, there are S_{dedicated}−1 possible switching points. The switching point is the point where the resources are changed from uplink to downlink or vice versa. The number of feasible uplink (UL) time slots is S_{UL}, where S_{UL}=1, 2, . . . , S_{dedicated}−1, and the number of downlink time slots is S_{DL}=S_{dedicated}−S_{UL}. For each possible switching point, the number of users that can be supported in the uplink (denoted by Nₘₐₓ_{_{—}}_{^{UL}}) is determined as the largest number of users that satisfies the condition P_{blocking}(j)≦P_{B}_{_{—}}_{^{req}}(j), ∀jε(1, 2, . . . , M−1) and \overline{D}≦D_{req} in the uplink. Similarly, the number of users that can be supported in the downlink (denoted Nₘₐₓ_{_{—}}_{^{DL}}) is determined as the largest number of users that satisfies the condition P_{blocking}(j)≦P_{B}_{_{—}}_{^{req}}(j), ∀jε(1, 2,. . . , M−1) and \overline{D}≦D_{req} in the downlink. The number of users that can be supported for each switching point, denoted by Nₘₐₓ, is given by min(Nₘₐₓ_{_{—}}_{^{UL}}, Nₘₐₓ_{_{—}}_{^{DL}}). The switching point that yields the largest number of users that can be supported as the optimal switching point between uplink and downlink for the TDD system is selected.

FIG. 3 is a flow diagram of optimum switch point determination for either a FDD or TDD system. The number of available frequency bands/time slots, S_{dedicated}, is determined, (step 10). For each of the possible, S_{dedicated}−1, switching points, a maximum number of the users for the uplink and downlink is determined, (step 12). The maximum number of users is the number of users that have blocking probability of real-time services (P_{blocking}(j)) less than or equal to the required blocking probability (P_{B}_{_{—}}_{^{req}}(j)) and have average delay of non-real time service (\overline{D}) less than or equal to the required delay (D_{req}). The users may be actual users of the system, if optimum switching is being used on a real time basis. As a result, the uplink and downlink resources can be dynamically changed. Alternately, the users may be based on statistical information on the service types typically used by the cell's users. As a result, the uplink and downlink resources may be fixed or changed periodically based on the statistical information.

For each switching point, the minimum number of users that can be supported in the uplink and downlink is selected as the number of users that can be supported by that switching point, (step 14). The switching point supporting the maximum number of users is selected, (step 16).

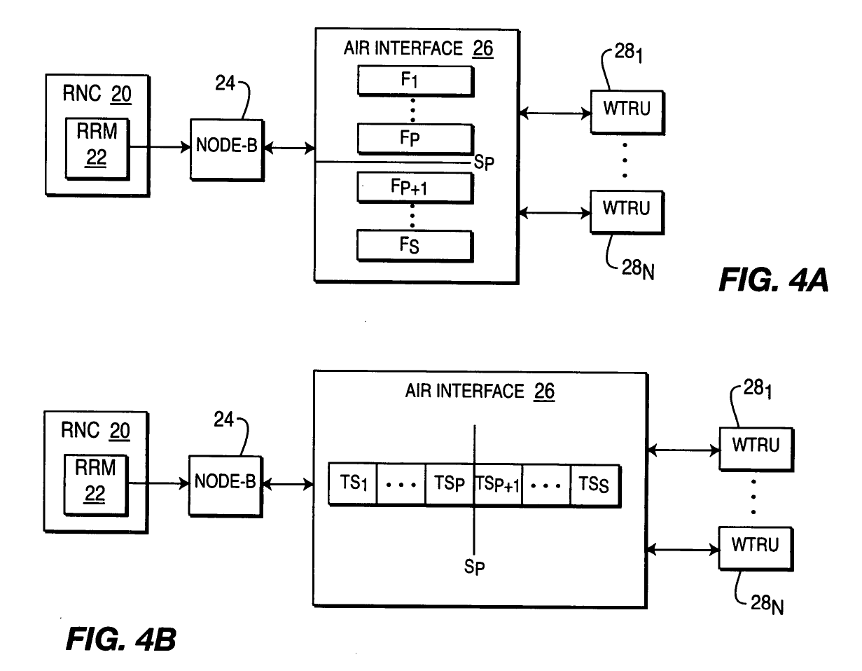

FIG. 4A is a simplified diagram of an FDD system using optimum switching points. A radio network controller (RNC) 20 has a radio resource manager (RRM) 22. The RRM 22 determines a switching point (SP) between the available uplink and downlink frequencies. Frequencies to be used for the uplink and downlink are communicated to a Node-B 24. Although shown as a Node-B as for a third generation partnership (3GPP) communication system, the Node-B may be a base station, site controller, access point or other interfacing device in a wireless environment.

Uplink and downlink communications are transferred between the Node-B 24 and WTRUs 28₁ to 28_{N} (28) via an air interface 26. A WTRU includes but is not limited to a user equipment, mobile station, fixed or mobile subscriber unit, pager, or any other type of device capable of operating in a wireless environment. As illustrated, the air interface has P frequencies, F₁ to F_{P}, for the uplink, and S−P frequencies for the downlink, F_{P+1} to F_{S}. As illustrated, the switching point (SP) is after P uplink frequencies out of the total of S available frequencies.

FIG. 4B is a simplified diagram of a TDD system using optimum switching points. A RNC 20 has a RRM 22. The RRM 22 determines a switching point (SP) between the available uplink and downlink time slots. The time slots may be on one frequency band or multiple frequency bands. Time slots to be used for the uplink and downlink are communicated to the Node-B 24. Uplink and downlink communications are transferred between the Node-B 24 and WTRUs 28 via an air interface 26. As illustrated, the air interface has P time slots, TS₁ to TS_{P}, for the uplink, and S−P time slots for the downlink, TS_{P+1} to TS_{S}. The switching point (SP) is after P uplink time slots out of the total of S available time slots.

What is claimed is:

1. A method for allocating resources in a wireless time division duplex communication system having a variable number of time slots allocated to support either uplink or downlink communications, the method comprising:
determining time slots available for allocation to support either uplink or downlink communications;
determining potential switching points between the available time slots, the switching points representing a change between time slots used to support uplink and downlink communications;
for each switching point:
for each of uplink and downlink, determining a number of user that can be supported by comparing a blocking probability of real time services with a required blocking probability of real time services and comparing an average delay of non-real time services with a required average delay of non-real time services; and
selecting a minimum of the uplink and downlink users that can be supported as the number of users that can be supported for that switching point; and
selecting the switching point having a maximum number of users that can be supported; and
allocating the available uplink and downlink time slots based on the selected switch point.

2. The method of claim 1 wherein the comparing the blocking probability of real time services with the required blocking probability is by determining whether the blocking probability of real time services is less than or equal to the required blocking probability.

3. The method of claim 2 wherein the required probability of a particular user being blocked is based on a service type of that particular user.

4. The method of claim 1 wherein the comparing the average delay of non-real time services with the required average delay of non-real time services is by determining whether the average delay of non-real time services is less than or equal to the required average delay of non-real time services.

5. The method of claim 4 wherein the required average delay of non-real time services for a particular user is based on a service type of that particular user.

6. A method for allocating resources in a wireless frequency division duplex communication system having a variable number of frequencies allocated to support either uplink or downlink communications, the method comprising:
determining frequencies available for allocation to support either uplink or downlink communications;
determining potential switching points between the available frequencies, the switching points representing a change between frequencies used to support uplink and downlink communications;
for each switching point:
for each of uplink and downlink, determining a number of user that can be supported by comparing a blocking probability of real time services with a required blocking probability of real time services and comparing an average delay of non-real time services with a required average delay of non-real time services; and
selecting a minimum of the uplink and downlink users that can be supported as the number of users that can be supported for that switching point; and
selecting the switching point having a maximum number of users that can be supported; and
allocating the available uplink and downlink frequencies based on the selected switch point.

7. The method of claim 6 wherein the comparing the blocking probability of real time services with the required blocking probability is by determining whether the blocking probability of real time services is less than or equal to the required blocking probability.

8. The method of claim 7 wherein the required probability of a particular user being blocked is based on a service type of that particular user.

9. The method of claim 6 wherein the comparing the average delay of non-real time services with the required average delay of non-real time services is by determining whether the average delay of non-real time services is less than or equal to the required average delay of non-real time services.

10. The method of claim 9 wherein the required average delay of non-real time services for a particular user is based on a service type of that particular user.

11. A radio network controller (RNC) allocating resources where a variable number of time slots can be allocated to support either uplink or downlink communications, the RNC comprising:
means for determining time slots available for allocation to support either uplink or downlink communications;
means for determining potential switching points between the available time slots, the switching points representing a change between time slots used to support uplink and downlink communications;
means for each switching point: for each of uplink and downlink, determining a number of user that can be supported by comparing a blocking probability of real time services with a required blocking probability of real time services and comparing an average delay of non-real time services with a required average delay of non-real time services; and selecting a minimum of the uplink and downlink users that can be supported as the number of users that can be supported for that switching point; and
means for selecting the switching point having a maximum number of users that can be supported; and
means for allocating the available uplink and downlink time slots based on the selected switch point.

12. The RNC of claim 11 wherein the comparing the blocking probability of real time services with the required blocking probability is by determining whether the blocking probability of real time services is less than or equal to the required blocking probability.

13. The RNC of claim 12 wherein the required probability of a particular user being blocked is based on a service type of that particular user.

14. The RNC of claim 11 wherein the comparing the average delay of non-real time services with the required average delay of non-real time services is by determining whether the average delay of non-real time services is less than or equal to the required average delay of non-real time services.

15. The RNC of claim 14 wherein the required average delay of non-real time services for a particular user is based on a service type of that particular user.

16. A radio network controller (RNC) allocating resources where a variable number of frequencies can be allocated to support either uplink or downlink communications, the RNC comprising:
means for determining frequencies available for allocation to support either uplink or downlink communications;
means for determining potential switching points between the available frequencies, the switching points representing a change between frequencies used to support uplink and downlink communications;
means for each switching point: for each of uplink and downlink, determining a number of user that can be supported by comparing a blocking probability of real time services with a required blocking probability of real time services and comparing an average delay of non-real time services with a required average delay of non-real time services; and selecting a minimum of the uplink and downlink users that can be supported as the number of users that can be supported for that switching point; and
means for selecting the switching point having a maximum number of users that can be supported; and
means for allocating the available uplink and downlink frequencies based on the selected switch point.

17. The RNC of claim 16 wherein the comparing the blocking probability of real time services with the required blocking probability is by determining whether the blocking probability of real time services is less than or equal to the required blocking probability.

18. The RNC of claim 17 wherein the required probability of a particular user being blocked is based on a service type of that particular user.

19. The RNC of claim 16 wherein the comparing the average delay of non-real time services with the required average delay of non-real time services is by determining whether the average delay of non-real time services is less than or equal to the required average delay of non-real time services.

20. The RNC of claim 19 wherein the required average delay of non-real time services for a particular user is based on a service type of that particular user.
